(19) United States
(12) Patent Application Publication
(10) Pub. No.: US 2021/0387620 A1
(43) Pub. Date: Dec. 16, 2021

(54) METHOD AND DEVICE FOR CONTROLLING A SPEED OR PROXIMITY CONTROL SYSTEM OF A TWO-WHEELED MOTOR VEHICLE

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 17/420,558

(22) PCT Filed: Jan. 30, 2020
(86) PCT No.: PCT/EP2020/052283

§ 371 Date: Jul. 2, 2021

(30) Foreign Application Priority Data
Apr. 11, 2019 (DE) 102019205245.2

(51) Int. Cl. B60W 30/16; B60W 50/10

(52) U.S. Cl. CPC B60W 30/16; B60W 2050/0064; B60W 50/10

(57) ABSTRACT

A method for controlling a speed or proximity control system of a two-wheeled motor vehicle. In the method, a voice command of the rider of the two-wheeled motor vehicle is picked up by a microphone; and at least one parameter of the speed or proximity control system is adjusted as a function of the voice command.

### BACKGROUND INFORMATION

German Patent Application No. DE 10 2017 201 698 A2 describes a method for controlling a speed control system of a two-wheeled motor vehicle, where after the rider activates the method, the speed of a second motor vehicle traveling directly ahead is ascertained and the speed of the motor vehicle traveling ahead is taken on by the motor vehicle; both increases and decreases in the speed of the motor vehicle traveling ahead being taken on.

### SUMMARY

The present invention relates to a method for controlling a speed or proximity control system, that is, adaptive cruise control (ACC) system, of a two-wheeled motor vehicle. In accordance with an example embodiment of the present invention, in the method:
a voice command of the rider of the two-wheeled motor vehicle is picked up by a microphone; and
at least one parameter of the speed or proximity control system is adjusted as a function of the voice command.

In this manner, the rider is allowed to assign parameters of a speed or proximity control system without using hands. In the two-wheeled vehicle branch, this is especially useful, since, in particular, during group rides, parameters of a speed or proximity control system are reassigned, as in the passenger car branch. Due to the voice control, the eyes of the rider remain trained on the road traffic.

In one advantageous embodiment of the present invention, the parameter is the distance from the vehicle traveling ahead, which is to be adjusted.

In one advantageous embodiment of the present invention, the parameter is the selection of an operating mode of the speed or proximity control system.

In one advantageous embodiment of the present invention, the operating mode is the selection of limiting values of operating dynamics variables during the control phases of the speed or proximity control system.

In one advantageous embodiment of the present invention, the operating mode is the selection of a target object for the speed or proximity control system.

In one advantageous embodiment of the present invention, the microphone is situated in the helmet of the rider.

In addition, the present invention includes an apparatus having devices, which are configured to implement the methods according to the present invention. This is, in particular, a control unit, in which the program code for implementing the methods of the present invention is stored.

### BRIEF DESCRIPTION OF THE DRAWING

FIG. 1 shows a method in accordance with an example embodiment of the present invention.

### DETAILED DESCRIPTION OF EXAMPLE EMBODIMENTS

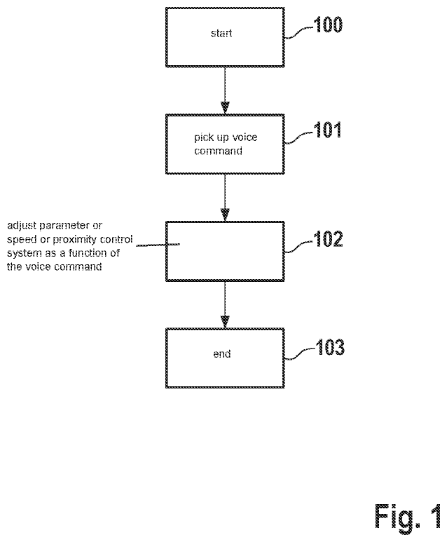

The basic sequence of the method according to an example embodiment of the present invention is shown in FIG. 1.

Since, in the case of a two-wheeled vehicle, the number of push-button switches and operator levers is considerably limited, a change of settings of a driver assistance system, such as a speed or proximity control system, is provided, e.g., via an operator menu. One option simpler than the operator menu is the use of voice control. To that end, for example, a Bluetooth headset may be used, which is integrated in the helmet of the rider and transmits the voice commands of the driver to the instrument cluster of the two-wheeled vehicle. In this manner, with the aid of voice commands, it is possible to change the system settings and/or the operating mode of a speed or proximity control system. For example, the target distance, that is, the distance from the vehicle traveling ahead, may be adjusted in different steps, or the operating mode of the speed or proximity control system may also be set to a “dynamic mode” and a “comfort mode.” In the “comfort mode,” for example, only accelerations and braking decelerations less than in the case of “dynamic mode” are permitted, which means that the “comfort mode” is more suited to the cautious driver and the “dynamic mode” is more suited to the sporty driver.

A further option is to specify the vehicle traveling ahead as a permanent target object by voice command. In this case, the speed or proximity control system even tracks the selected vehicle, when it is no longer directly in front of the reference vehicle. This embodiment is suitable, above all, for group rides of motorcyclists.

The basic sequence of the method according to the present invention is shown in FIG. 1.

After the start of the method for controlling a speed or proximity control system of a two-wheeled vehicle in block 100,
in block 101, a voice command of the rider of the two-wheeled motor vehicle is picked up by a microphone; and
in block 102, at least one parameter of the speed or proximity control system is adjusted as a function of the voice command.

The method ends in block 103.

1-8. (canceled)

9. A method for controlling a speed or proximity control system of a two-wheeled motor vehicle, comprising:
picking up a voice command of a rider of the two-wheeled motor vehicle by a microphone; and
adjusting at least one parameter of the speed or proximity control system of the two-wheeled motor vehicle as a function of the voice command.

10. The method as recited in claim 9, wherein the at least one parameter includes a distance from a vehicle traveling ahead.

11. The method as recited in claim 9, wherein the parameter is a selection of an operating mode of the speed or proximity control system.

12. The method as recited in claim 11, wherein the operating mode is a selection of limiting values of operating dynamics variables during control phases of the speed or proximity control system.

13. The method as recited in claim 11, wherein the operating mode is a selection of a target object for the speed or proximity control system.

14. The method as recited in claim 9, wherein the microphone is situated in a helmet of the rider.

15. The method as recited in claim 9, wherein the two-wheeled motor vehicle is a motorcycle.

16. An apparatus configured to control a speed or proximity control system of a two-wheeled motor vehicle, the apparatus configured to:
pick up a voice command of a rider of the two-wheeled motor vehicle by a microphone; and
adjust at least one parameter of the speed or proximity control system of the two-wheeled motor vehicle as a function of the voice command.
